(19) United States
(12) Patent Application Publication
(10) Pub. No.: US 2025/0141398 A1
(43) Pub. Date: May 1, 2025

(54) CONSTRUCTION ARRANGEMENT FOR SUPPORT STRUCTURE OF PHOTOVOLTAIC PANELS

(71) Applicant: INFINITE PHOTON SERVIÇOS DE CONSULTORIA LTDA, Santo Antônio do Amparo (BR)

(72) Inventors: Rodrigo CARRARA PEIXOTO, Minas Gerais (MG) (BR); Fernando DINIZ QUEIROZ, Belo Horizonte (MG) (BR); Bruno FREITAS CAMPOS, Belo Horizonte (MG) (BR)

(73) Assignee: INFINITE PHOTON SERVIÇOS DE CONSULTORIA LTDA, Santo Antônio do Amparo (BR)

(21) Appl. No.: 18/932,972

(22) Filed: Oct. 31, 2024

(30) Foreign Application Priority Data
Nov. 1, 2023 (BR) 202023022955-2

(51) Int. Cl. H02S 20/32

(52) U.S. Cl. CPC H02S 20/32

(57) ABSTRACT

This innovation involves an innovative structure for supporting and moving photovoltaic panels joined by a structure using transverse rafters supported by a central bar, the torque axis, suspended and supported by spaced-apart stakes that are moved by an actuator motor to allow the panels to be angled according to the convenience and need for capturing sunlight.

### FIELD OF INNOVATION

This innovation concerns an arrangement for the construction of structures for supporting and moving solar panels, more specifically an innovative set of elements that are combined to form a module for erecting structures intended to support photovoltaic panels.

### HISTORY OF INNOVATION

Current systems for supporting solar panels, although they solve most of the most immediate and generic problems, lack solutions for the specific problems arising from their use to support these photovoltaic modules.

In this application, difficulties arise from everyday use, especially with regard to resistance to weather and wind forces, which overload the structure with additional stresses that are often not considered in the structure's design.

Thus, mechanisms for preventing additional efforts, whether they have a robust construction or a flexible constitution, constitute the set of elements provided in the structure of the present innovation which, when combined, make up the global scope of the innovative structure.

It should be noted that the parts of the set presented here are manufactured by casting, which eliminates the need for welding and the consequent inspection and evaluation process.

### DISCUSSION OF THE STATE OF THE ART

U.S. Pat. No. 7,252,084 describes a solar tracking system that drives motors from the signal of transducers to change the vertical and horizontal orientation of a solar collector, the transducers having thermal contact with a thermal mass and communication to perceive the output voltage of the solar cells of the solar collector.

Document U.S. Pat. No. 9,466,749 deals with a solar tracker apparatus comprising a center of mass arrangement with an adjustable suspension assembly such that the center of mass is aligned with a center of rotation of cylindrical torque tubes to reduce the load of a drive motor coupled to the cylindrical torque tube.

Application US20080308091 discloses a solar tracking system with a torque tube supporting solar panels with columns supporting the system and having bearings for rotation of the torque tube, where a drive is coupled to the torque tube being driven by a gearbox to rotate the solar panel array to follow the diurnal movement of the sun.

The innovation described in US20080308091 shows a solar tracking system for mounting on flat surface roofs that includes solar tracking assemblies mountable in the same orientation on the roof, comprising a mounting structure, a steering mechanism and one or more solar energy to electrical energy conversion units, the steering mechanism supported at least in part by the mounting structure and the energy conversion units driven by the steering mechanism, where a drive mechanism drives the steering mechanisms and a control processor that controls the drive mechanism so that the energy conversion units track the sun.

Document US20140053825 discloses a single-axis arrayed solar tracker and its drive system having at least two rows of solar trackers and a drive mechanism, wherein the rows are parallel and each row shares a common axis of rotation, having a rigid torque arm perpendicularly connected to the axis of rotation, and wherein the drive mechanism has at least one rotary driver whose axis of rotation is parallel to the axes of rotation of the tracker, wherein the torque driver and tracker torque arms are rigidly and perpendicularly connected, the drive torque arm and the tracker torque arms being articulated with a series of rigid beams perpendicular to the axes of rotation of the driver and the driver, wherein the rotary driver rotates and creates a rotational motion and the driver torque arm follows the rotational motion of the driver, generating linear push and pull motion in the link beams that drive the tracker torque arms, swinging the rows of solar trackers to rotate in around their axes and to follow the movement of the sun.

Document US20160123383 describes a solar panel tracker positioning system wherein a bearing has a semicircular shaped inner face having a first elevation and a second elevation on the opposite face, having a first elongated opening positioned in proximity of the first elevation and a second elongated opening positioned in proximity of the second elevation, and further a first alignment ring centered within the first elongated opening and a second alignment ring centered within the second elongated opening, the inner face of the bearing also including a grounding pin integrally connected to the body so as to fuse therewith.

Brazilian application BR202019001848-3 explains a structure for supporting and moving photovoltaic modules joined by a malleable element, composed of the association of elements planned for this purpose, articulated in a cast stake head attached to parallel metal beams, forming a set with the smallest number of components.

None of the cited references advance the inventive concepts of the innovation proposed here, covering the structure for supporting photovoltaic panels where elements are combined to form a module used to form a support and movement structure.

### DESCRIPTION OF FIGURES

FIG. 1 presents a schematic representation of the structure (1) provided by the arrangement of the present innovation, where the association of multiple modules (2) can be seen among themselves.

FIG. 2 shows the base of the structure provided by the arrangement of this innovation, where the stakes (15) and the central stake (16) can be seen spaced apart, supporting the torque beam (6).

FIG. 3 shows the structure (1) provided by the arrangement of the present innovation, where details 3A and 38 can be seen.

FIG. 3A shows the detail where the rafter (3), the pillar (4), the base of the torque beam (5), the torque beam (6), the harness (7), the spherical joint (10) and the joint (13) can be seen.

FIG. 3B shows the detail where the actuator motor (9), the torque arm (11), the fixing base (12) and the actuator head (14) can be seen.

FIG. 3C shows the detail where the arrangement between the torque beam (6), the harness (7) and the clamp (8) can be seen.

FIG. 4 shows the angle at which each module (2) can vary to position each panel, at an angle of 55° to the right (44) or to the left (48).

FIG. 5 represents each module, where the rafter (3), the pillar (4), the base of the torque beam (5), the torque beam (6) and the harness (7) can be seen.

FIG. 6 shows the fixing system used in the arrangement of this innovation, where the torque beam (6) can be seen supported by the torque beam base (5) embedded in the pillar (4) and being fixed by the ball joint (17) and the upper casing (18), in addition to the holes for embedding (19).

FIG. 7 shows the joining system used in the arrangement of this innovation, where two torque beams (6) can be seen joined by a clamp (8), in addition to the holes for crimping (19).

FIG. 8 shows the components of the structure to perform the rotation of the arrangement of the present innovation, where the pillar (4), the base of the torque beam (5), the torque arm (11), the actuator head (14) the label (17), the upper casing (18) and the projection for crimping (20) can be seen.

FIG. 9 shows the structure for rotating the arrangement of this innovation, where the pillar (4), the base of the torque beam (5), the torque beam (6), the torque arm (11) and the actuator head (14) can be seen, in addition to the holes for mounting (19).

FIG. 10 shows the structure to actuate the rotation of the arrangement of the present innovation, where the torque beam (6), the torque arm (11), the actuator head (14) and the actuator motor (9) can be seen.

FIG. 11 shows the attachment of the actuator motor (9) of the arrangement of the present innovation, where the pillar (4) and the articulation point (21) can be seen.

FIG. 12 illustrates the structure for supporting the panels of the arrangement of this innovation, where the rafter (3), the torque beam (6), the harness (7) and the clamp (8) can be seen.

FIG. 13 illustrates a side view of the arrangement of the present innovation, where the rafter (3), the torque beam (6), the harness (7), the clamp (8) and the panels (22) can be seen.

### DETAILED DESCRIPTION OF THE INNOVATION

The present innovation deals, in summary, with a structure (1) for supporting photovoltaic panels (22), composed of a set of modules (2) that, associated with each other, form a longitudinal structure (1) that, when activated, is capable of rotating the panels (22) according to the need to improve the capture of sunlight.

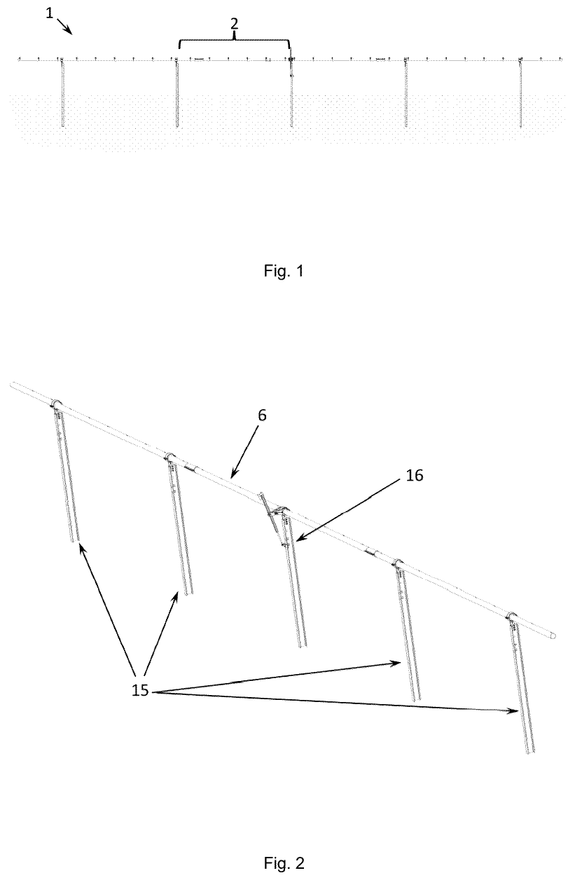

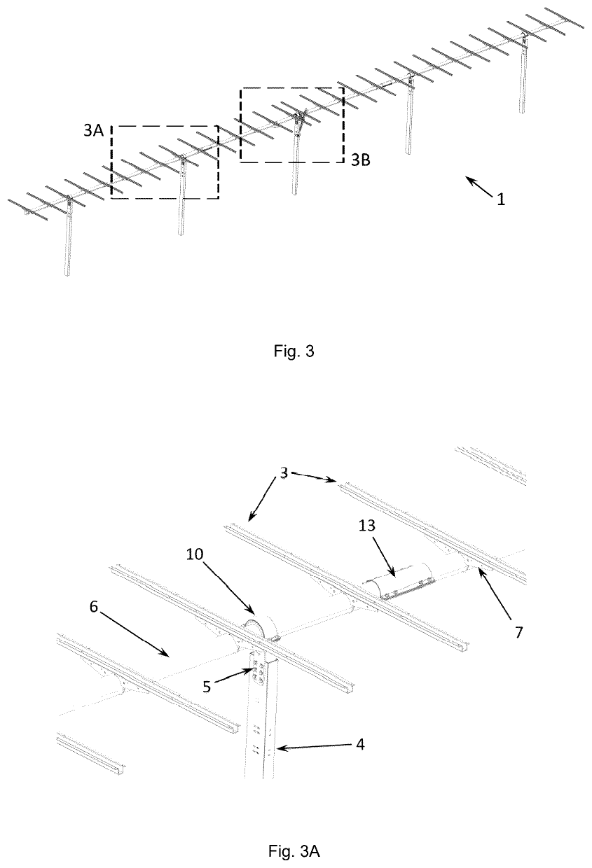

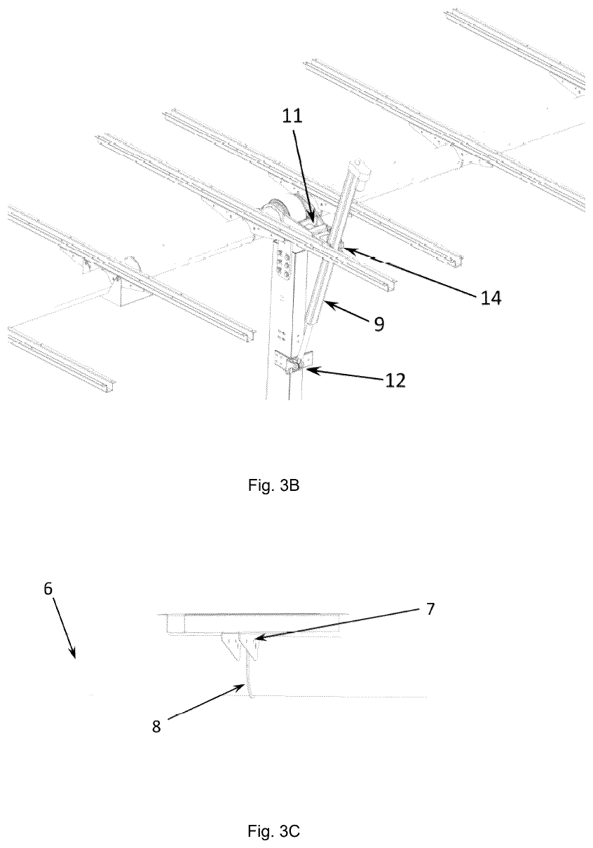

Each module (2) of the structure (1) of the present innovation is capable of supporting and manipulating a panel (22), being composed of the association of two stakes (15) that support the torque beam (6) and on which rest, spaced apart, a set of transverse supports, as seen in FIGS. 1, 2 and 3.

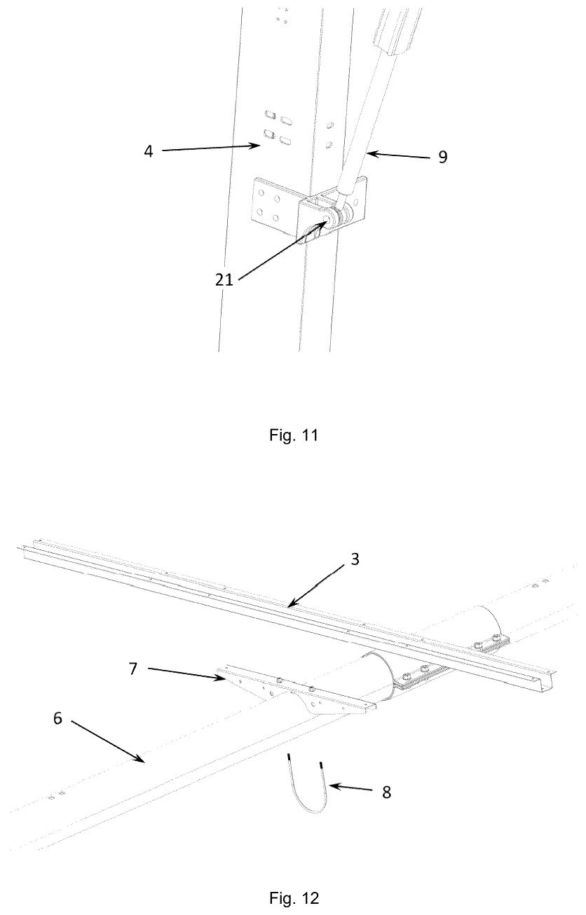

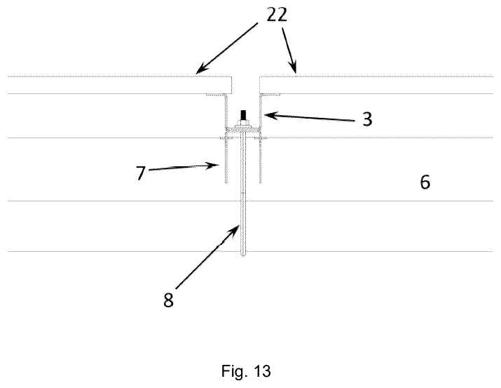

These transverse supports are formed by the association of a rafter (3) and a harness (7), fixed to the torque beam (6) by a clamp (8), as shown in FIGS. 12 and 13. This clamp (8) can assume different shapes, with the preferred configuration here being a “U” element with threads at its ends.

As can be seen, each rafter (3) is capable of receiving two panels (22), one on each edge, allowing the formation of a sunlight-collecting surface by several associated panels (22).

The stakes (15), in turn, are elongated elements and composed of a pillar (4), which consists of a rod placed in a vertical position, attached to the ground and which, at its upper end, has a base for the torque beam (5), which is presented as an elongated piece in whose upper portion it has a semicircular concave receptacle that accommodates one of the halves of the ball joint (17), as shown in FIGS. 5, G and 8. This upper portion is finished off by an upper casing (18), also in a semicircular concave shape, coinciding with that of the base of the torque beam (5), and which accommodates the other half of the ball joint (17), in order to form the grip of the torque beam (6).

Preferably, the pillar (4) is presented as a metal bar with a “C” profile, so that it can withstand the forces to which it is subjected. Additionally, the part has a plurality of holes for mounting and fixing the other elements, such as the base of the torque beam (5) and the torque arm (11).

Thus, the juxtaposition of several modules (2) forms the structure (1) provided for in this innovation, capable of supporting and moving photovoltaic panels.

In the structure (1) formed, there is at least one central stake (16), as shown in FIG. 2, equipped with mechanisms for moving the structure (1).

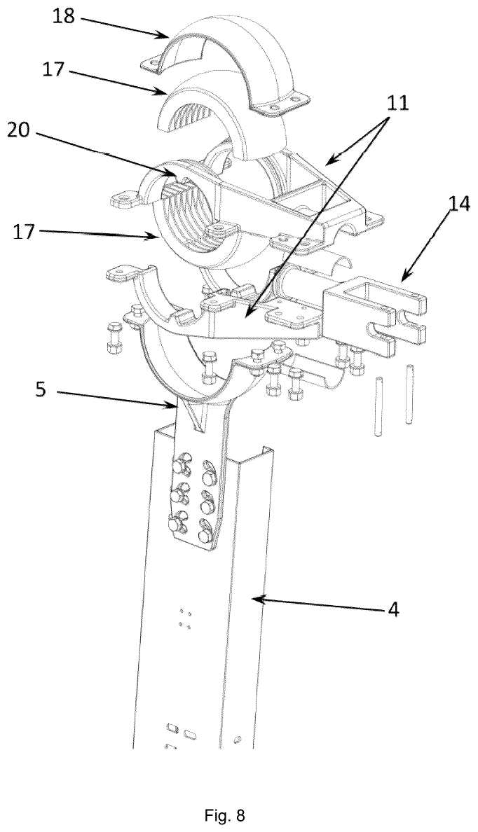

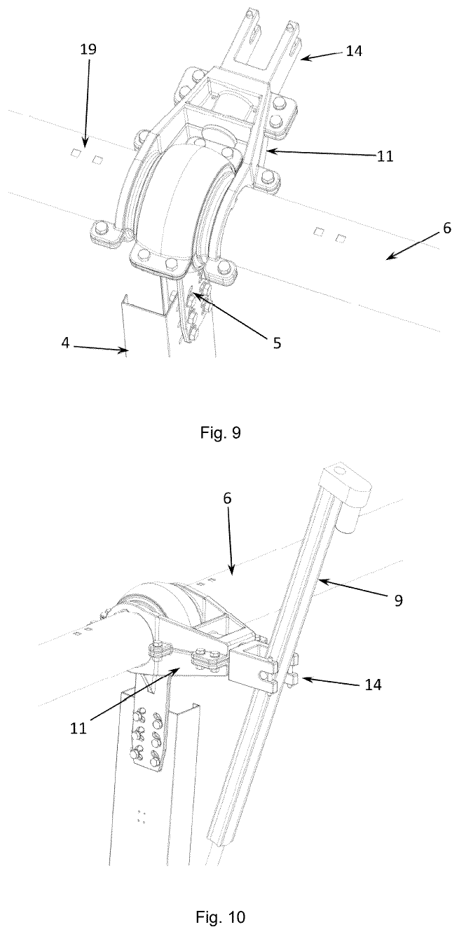

The central stake (16), like the other stakes (15), also has a pillar (4) attached to a base of the torque beam (5) enclosed by an upper casing (18) and accommodating a ball joint (17). However, this assembly is associated with a torque arm (11), which consists of an elongated element that forms a projection from the upper portion of the central stake (16) and which accommodates, at its end, the actuator head (14), as shown in FIGS. 8 and 9.

It is worth noting that the upper casing (18) assembly and torque beam (5) base enclose the ball joint (17) so that it is mobile and, therefore, its axial movement within the assembly allows adaptation around the torque beam (6), making it possible to compensate for any misalignments between the stakes (15, 16) and maintaining the functionality of the structure (1) of this innovation.

The torque arm (11) has, in each of its halves, at least one projection for crimping (20) coinciding with at least one hole for crimping (19) present in the torque beam (6). In this way, the appropriate locking between the parts is promoted to allow the rotation of the torque beam (6) and the movement of the structure from the central stake (16).

In order to generate the mechanical force required to move the structure (1), an actuator motor (9) is fixed to the pillar (4) of the central stake (16) by means of a joint (21), as seen in FIG. 11, and attached to the actuator head (14), as shown in FIG. 10. Then, when the motor (9) is activated, the torque arm (11) moves through the interaction of the actuator motor (9) with the actuator head (14) and, consequently, the interaction of the torque arm (11) with the torque beam (6) allows the movement of the structure.

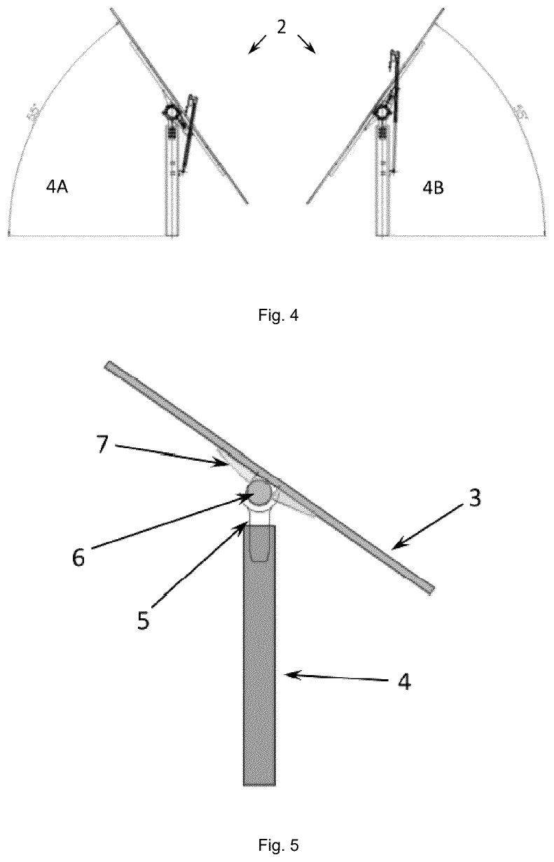

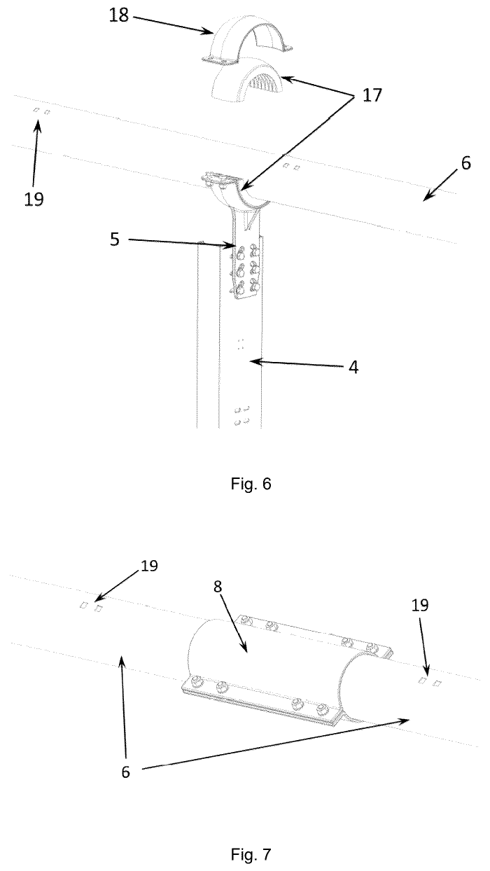

The movement of the structure (1) occurs by rotating the torque beam (6) clockwise or counterclockwise when driven by the actuator motor (9), thus promoting the inclination of the panels (22) in the same direction, by means of angles of each module (2) of up to 55° to the right (44) or to the left (48), as shown in FIG. 4.

To join the torque beams (6) in order to extend the structure (1) longitudinally, two pieces are joined using a clamp (8), as shown in FIG. 7, fixing them to form a single set.

It is worth noting that the structure proposed in this solution has fewer component elements than similar ones intended for the same application. With fewer items, there is also the generation of fewer splice points, minimizing the variation points and, therefore, increasing the stability and reliability of the structure thus formed.

A structure formed according to the present solution is also more stable due to the formation using only 3 torque axes, sufficient for the proper functioning of the proposed structure.

The use of fewer components also implies their rationalization, which facilitates the assembly of the structure, as well as the transportation of the set of components to the installation site.

Another advantage worth mentioning is the use of parts that are easily replaceable in the event of maintenance, without the need to disassemble a significant part of the structure to restore it for use.

The fact that it has a round shaft is also a significant operational advantage, given that this profile optimizes the transfer of energy to move the panels supported there.

And finally, the structure presented here does not require the use of lubricants, minimizing wear and the need for interventions to ensure the continued operation of the unit.

The various component parts of the structure presented here are preferably forged in a foundry, thus dispensing with the use of welds to promote their conformation and thus avoiding the costly process of inspections to evaluate the welds, commonly carried out on parts welded for the same purpose.

This invention is not limited to the embodiments discussed or illustrated herein, and should be understood in its broad scope. Many modifications and other embodiments of the invention will come to the mind of one skilled in the art to which this invention belongs, having the benefit of the teaching set forth in the foregoing descriptions and accompanying drawings. Furthermore, it is to be understood that the invention is not limited to the specific form disclosed, and that modifications and other forms are intended to be included within the scope of the appended claims. Although specific terms are employed herein, they are used only in a generic and descriptive manner and not for the purpose of limitation.

1. A construction arrangement for support structure of photovoltaic panels, comprising: a set of modules associated with each other to form a longitudinal structure arranged and configured to rotate the panels, said modules being composed of the association of two stakes which support a torque beam and on which rest, spaced apart, a set of transverse supports formed by the association of a rafter and a harness, fixed to the torque beam by a clamp, said stakes including a pillar and a base of the torque beam closed by an upper casing and enclosing a movable ball joint, said structure comprising at least one central stake formed by a pillar set into a base of the torque beam closed by an upper casing and accommodating a movable ball joint and a torque arm associated with an actuator head, said torque arm presenting, in each of its halves, at least one projection for crimping coinciding with at least one hole for crimping present in the torque beam, said central stake also accommodating an actuator motor fixed to the pillar by means of a joint and crimped to the actuator head, said structure being lengthened longitudinally by the union of torque beams using a clamp.

2. The construction arrangement for supporting structure for photovoltaic panels, as described in claim 1, wherein for having the movement of the structure on slopes of up to 55° to the right or left.
